(19) United States
(12) Patent Application Publication
(10) Pub. No.: US 2020/0147793 A1
(43) Pub. Date: May 14, 2020

(54) ROBOT

(71) Applicant: Hewlett-Packard Development Company, L.P., Spring, TX (US)

(72) Inventors: Tina M. LARSON, Corvallis, OR (US); William J. ALLEN, Corvallis, OR (US)

(73) Assignee: Hewlett-Packard Development Company, L.P., Spring, TX (US)

(21) Appl. No.: 16/473,448

(22) PCT Filed: Apr. 6, 2017
(86) PCT No.: PCT/US2017/026307

§ 371 Date: Jun. 25, 2019

(51) Int. Cl. B25J 9/16

(52) U.S. Cl. CPC B25J 9/1628; B25J 9/1661; B25J 9/1674; B25J 9/1697

(57) ABSTRACT

Some examples include a method of operating a robot including receiving a task assignment for the robot, initiating a sequence of operations associated with the robot performing the task assignment, sensing an interruption event to the sequence of operations at a first location of the robot, interrupting the sequence of operations, referencing a database of assistant resources, determining available assistant resources from the database of assistant resources, selecting an available assistant resource from the database to assist with resolving the interruption event at the first location, transmitting a communication requesting assistance to the selected available assistant resource to assist at the first location, sensing when the interruption event has been resolved, and resuming the sequence of operations from the interruption event.

### BACKGROUND

Robots are machines that are capable of carrying out a series of actions automatically. Robotic devices can be used in multipurpose applications such as in industrial, consumer, and military applications, for example. Robots can interact with other electronic devices or humans.

### BRIEF DESCRIPTION OF THE DRAWINGS

FIG. 1 is a diagrammatic view of a robot in accordance with aspects of the present disclosure.

FIG. 2 is a diagrammatic view of a robotic system useful with the robot of FIG. 1 in accordance with aspects of the present disclosure.

FIG. 3 is another diagrammatic view of a robotic system in accordance with aspects of the present disclosure.

FIG. 4 illustrates a flow chart of an example method of operating a robot in accordance with aspects of the present disclosure.

FIG. 5 illustrates a flow chart of another example method of operating a robotic system in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples provide robotic systems including robots and methods of operating the same. Robots and robotic systems can provide assistance to humans in many applications. In some examples, robotic devices can sense and react to environments and surroundings to complete assigned tasks to assist humans. Tasks can be any suitable for being performed using a robotic device using a set of dynamic actions performed in a sequence of operations to accomplish a goal. For example, tasks can involve maneuvering through controlled or uncontrolled environments. As robots move into more uncontrolled environments that can be crowded with obstacles and moving people, situations that are beyond the capabilities of the robot can be encountered. In some cases, robots can have limited mobility or functionality and assistance from humans in completing tasks can be helpful. Communication to a human, or humans, for assistance while the human is performing a task unrelated to the robot can be disruptive to the humans. It is desirable to selectively communicate assistance requests to humans available and most appropriate to assist the robot in order to be least disruptive to a group of humans.

In accordance with aspects of the present disclosure, robots can include the ability to request assistance from others when it is determined that the robot cannot successfully complete a task due to an obstacle or interruption event. An interruption event to the sequence of operations can be a physical obstacle or barrier, a programming limitation, a perception limitation, or other event that creates an interruption to the performance of robot 10, for example. The robot or robotic system can signal for assistance to nearby or remote humans if a determination is made that the robot is otherwise unable to complete the task. By soliciting assistance from humans, robots can perform a wider range of tasks than robots can perform without assistance. Human-robot interaction, for example, human augmentation of robotic work can be useful when a robot encounters a situation that interrupts the sequence of operation to the assigned task. However, robots requesting assistance can interrupt humans performing other tasks. In accordance with aspects of the present disclosure, robots can leverage assistance from people to efficiently and economically accomplish a variety of tasks while minimizing interruption to humans by selectively requesting assistance. Working together, humans and robots can use complementary strengths to complete tasks.

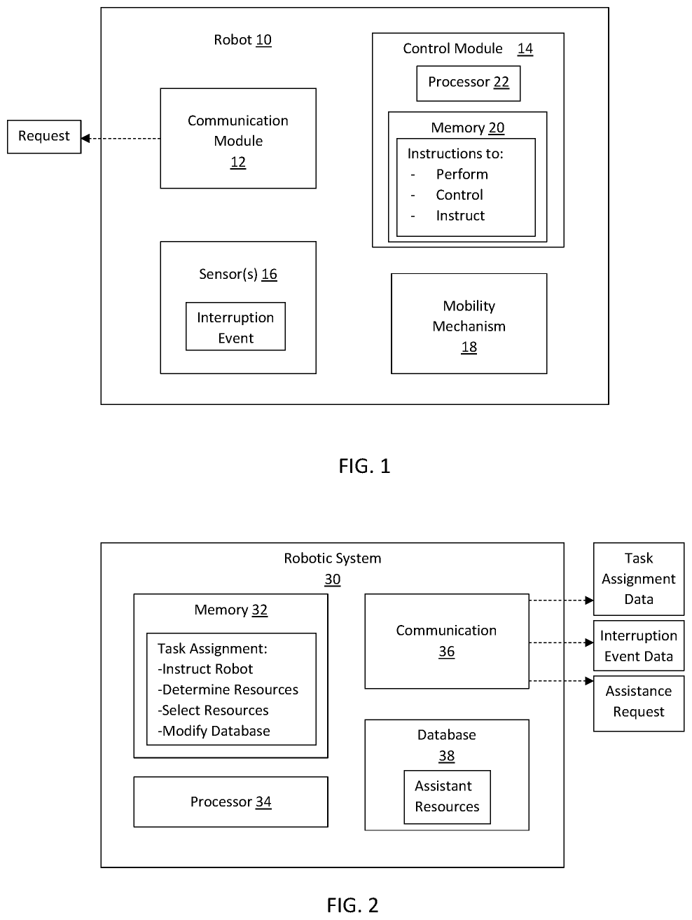

FIG. 1 is a diagrammatic illustration of a robot 10 in accordance with aspects of the present disclosure. Robot 10 includes a communication module 12, a control module 14, at least one sensor 16, and a mobility mechanism 18. Robot 10 can be any robotic device suitable to operate in a desired environment and perform assigned tasks. Robot 10 can be autonomous, performing behaviors or tasks with a high degree of autonomy, or semi-autonomous. Robot 10 can be any type of mobile or fixed location robotic device capable of operating in an environment including on land, in water, in air, in space, or the like. For example, robot 10 can be a drone, a driverless vehicle, or any other configuration of a robotic device that can carry out a complex series of actions and is not limited to a specific form or function. Robot 10 can perform a sequence of operations, or a set of subtasks, related to a task assignment in a fully automated manner and/or as augmented by a human or other assistant resource, as described further below.

Mobility mechanism 18 effectuates movement of robot 10 through an environment and through a sequence of operations associated with robot 10 performing a task assignment. In one example, mobility mechanism 18 of robot 10 includes at least one drive motor operable to propel robot 10 across a surface, such as a floor, in the environment. Mobility mechanism 18 can include wheels, rollers, propellers, pneumatic operators, or other suitable mechanisms to provide mobility and movement to robot 10 through or within an environment to complete tasks. In one example, mobility mechanism 18 can include a multi-linked manipulator to provide movement of select portions of robot 10 to manipulate objects to accomplish tasks. Mobility mechanism 18 can effectuate movement of robot 10 through and within environments of land, air or water, for example.

Robot 10 includes sensors 16 as appropriate to assist robot 10 to accomplish a set of tasks expected to be performed by robot 10. Robot 10 includes at least one sensor 16 and can include one or multiple of the same or differing types of sensors. At least one sensor 16 can aid robot 10 in navigating through an environment and manipulating objects. Sensor 16 can also be used to aid interaction of robot 10 with objects and humans. Sensors 16 to aid in interaction of robot 10 with objects and humans can be useful in dynamic environments, for example, where objects and humans are not stationary. Robot 10 can employ sensors 16 to behave autonomously based on surrounding and internal situations sensed by sensors 16. Examples of sensors 16 can include, but is not limited to, a sensing device such as camera, microphone, touch sensor, acceleration sensor, battery sensor, global positioning sensor, radar, inertial measurement device, chemical sensor, impact or vibration sensor. Other types of sensors 16 can also be employed. In one example, a first sensor 16ₐ can sense an event or obstacle that interrupts the sequence of operations employed to complete an assigned task and a second sensor 16_{b} can sense when the interruption event has been resolved. In one example first and second sensors 16ₐ, 16_{b} are the same sensor 16. Sensors 16 can aid robot 10 with sensing the environment in order to navigate, respond to the environment, and efficiently utilize assistant resources.

Control module 14 can provide control to movements of mobility mechanism 18. Control module 14 includes memory 20 to store instructions and a processor 22 to execute instructions in order to perform the sequence of events associated with robot 10 performing task assignments. Processor 22 can control the operation of robot 10 through the performance of the sequence of operations useful in completing assigned tasks, along with providing an interface for communication module 12 and sensors 16. Processor 22 can execute instructions to interrupt the sequence of operations in response to a sensed interruption event.

Communication module 12 can receive instructions related to task assignments assigned to robot 10 to perform. In one example, communication module 12 can receive instructions through wireless communication. Communication module 12 can be employed transmit at least one of data, audio, and video sensed by sensors 16 as discussed further below.

FIG. 2 is a diagrammatic view of a robotic system 30 useful with robot 10 of FIG. 1, in accordance with aspects of the present disclosure. Robotic system 30 includes memory 32, a processor 34, a communication system 36, and a database 38. Examples of robotic system 30 are employed to manage (e.g., store, retrieve, create, manipulate, organize, present, etc.) data and communication related to task assignments for one or multiple robots 10, as described further below.

Memory 32 can be used to store a plurality of task assignments to be assigned to one or a plurality of robots 10. Processor 34 can process the task assignments to select and instruct a robot 10 to perform a sequence of operations associated with the task assignment. The sequence of operations can be defined, and refined, at processor 34 of system 30 and/or processor 22 of robot 10 in accordance with the assigned task, interruption event, and environmental surroundings.

Communication system 36 can receive and transmit data related to the task assignment between processor 34 and communication module 12 of robot 10. Communication system 36 can communicate data to robot 10 related to performing the sequence of operations. In some examples, communication system 36 can communicate with a network device (not shown) associated with the assistant resource for receiving a communication request for assistance to resolve the interruption event to the task assignment. In one example, a separate network device is associated with each assistant resource and communication can be via an application program, email, text, or other electronic communication to the network device. Alternatively, or in addition, robot 10 can issue audio or visual communication.

Database 38 includes information associated with assistant resources. The information associated with assistant resources is entered into database 38 and modified either automatically or through user input. Processor 34 can determine available assistant resources from database 38 and select available assistant resource(s) from database 38 to assist with resolving the interruption event. Database 38 can track a response of the assistant resource(s) to the interruption event. Processor 34 can modify information related to the assistant resources' response to the interruption event for storage in database 38.

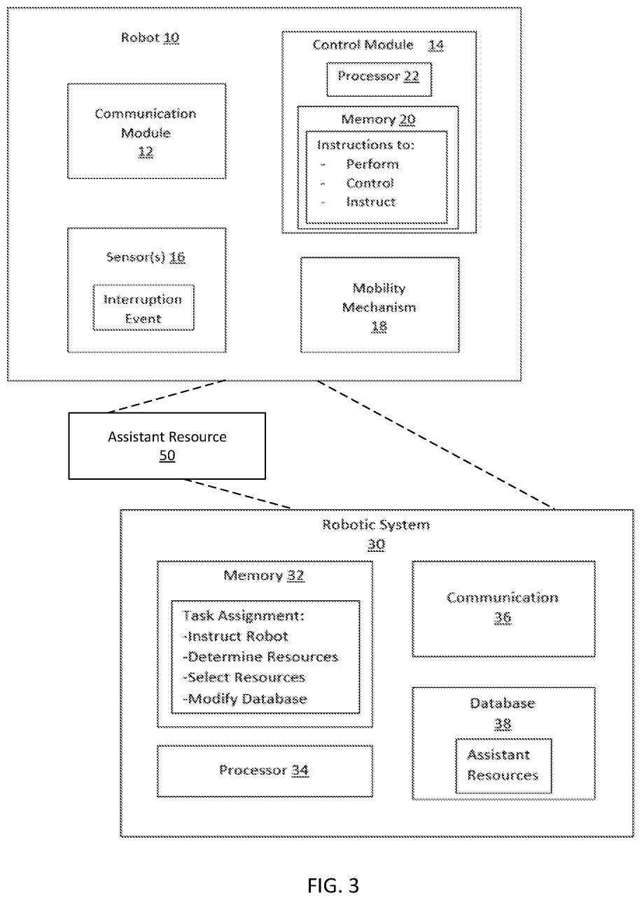

FIG. 3 is another diagrammatic view of another robotic system 40 in accordance with aspects of the present disclosure. System 40 includes robot 10, robotic system 30, and an assistant resource 50. Although only one robot 10, robotic system 30, and assistant resource 50 is illustrated, it is noted that a plurality of each or any can be employed. In one example, assistant resource 50 can include humans and/or other robotic devices. Assistant resource 50 can include a group of at least one available assistant resource and can include unavailable assistant resources. Available assistant resources can become unavailable assistant resources and vice versa. Each assistant resource is included in database 38 and can be automatically included as available (e.g., scanned) or can elect to be included in database 38 as available and change the elected status at any time as suitable to their desires in assisting with assistant requests or in order to perform unrelated tasks. In one example, a human can electronically log into a system to elect to be an available assistant resource. In another example, a human that clocks into a work payroll system is included in database 38 as an available assistant resource without additionally electing to be included as available. Database 38 can continuously track and record the availability status of each assistant resource. Assistant resources that have elected or been determined to be unavailable are not contacted with assistance requests.

In one example, robot 10 can be selected by system 30 from a group of robots 10₁ . . . 10ₓ employed by system 30 to perform a task assignment. Information related to each of robots 10₁ . . . 10ₓ can be stored in memory 32. Robot 10 can be selected based on any appropriate set of criteria including, but not limited to, availability, proximity to a starting location of assigned task, mechanical capabilities, etc. As illustrated by dashed lines, robot 10, robotic system 30, and assistant resource 50 can interact and communicate with each other. For example, assistance resource 50 and robot 10 directly or indirectly communicate with assistant resource 50 through a networking device (e.g., computing device, phone). Robot 10 and robotic system 30 can wirelessly communicate.

In accordance with aspects of the present disclosure, robotic system 30 can include at least one robot 10 that can solicit assistance by issuing an assistance request in an event that robot 10 is impeded from completing an assigned task. For example, if robot 10 senses an interruption event (i.e., obstacle, physical or otherwise) that prevents robot 10 from completing a sequence of operations associated with completing the assigned task, information associated with the sensed interruption event is processed to determine whether assistance is to be requested or if the sequence of operations can be modified to overcome the interruption event. Database 38 of assistant resources can be analyzed and appropriate assistant resources are selected and communicated with to request assistance in resolving the interruption event. The assistant resources can be nearby or remote humans or other robotic devices, for example. Each assistant resource can independently elect to assist the robot resolve the interruption event. Upon resolution of the interruption event, the robot can continue through the sequence of events to complete the assigned task. Through system 40, either at one of robots 10 or at system 30, database 38 of assistant resources can be analyzed to solicit and engage assistance from the assistant resources in a prioritized manner to be least disruptive to the assistant resources.

In order to be least disruptive, task assignments and assistance requests can be prioritized by system 30. Task assignments can be routed and scheduled to a plurality of robots 10 to effectively manage the tasks. System 30 determines and assigns a task to the best suited robot for a given task. System 30 manages a set of assistant resource to select one or more available assistant resources to assist robot 10 in resolving the interruption event.

With additional reference to FIGS. 1 and 2, sensed data from sensors 16 of robot 10 can provide data to be processed by processor 34 for tracking robot 10 when assigning and monitoring tasks to be completed, as described further below. Robot 10 can transmit sensed data from sensors 16 through communication module 12 to communication system 36 within system 40, including to other robots 10, assistant resources 50, and users (not shown).

Robot 10 may be unable to complete the task assignment due to an interruption event. Interruption events can encompass any event or obstacle that impedes robot 10 in completing the assigned task and occurs in a manner that robot 10 is not able to overcome without assistance. Progression of robot 10 through the sequence of operation can be tracked to provide for evaluation and prioritization of assistance requests for resolving the interruption event and completion of the assigned task. Communication system 36 can communicate an assistance request to the selected available assistant resource to assist resolving the interruption event independent from robot 10. At least one available assistant resource can be selected that is determined to be best suited to handle the interruption event confronting robot 10. Sensor 16 of robot 10 senses that the interruption event has been resolved in order for robot 10 to resume the sequence of operation to complete the assigned task. Sensor 16 used to initially sense the interruption event can be the same or different sensor 16 used to sense resolution of the interruption event.

In one example, robot 10 can be assigned a task of delivering an item from a first user on a first floor of a building to a second user on a third floor of the building. Robot 10 can navigate through the first floor of the office building and be unable to transfer to the third floor due to being unable to press an elevator call button in order to transfer between the floors of the building. For example, robot 10 may not have “arms” capable of pushing an elevator call button. Upon robot 10 sensing an interference to the assigned task using external sensors 16, the sequence of operations can be temporarily halted (i.e., paused). Determination of whether robot 10 can overcome or work around the interference can be performed. If robot 10 or system 30 determines that robot 10 cannot overcome or work around the interruption event, robot 10 seeks assistance by an issuing assistance request. In some examples, robot 10 communicates the interruption event occurrence with system 30, and system 30 selects the best available assistant resource(s) and issues electronic assistance requests to the selected available assistant resource(s). Robot 10 can issue an assistance request based on the sensed interruption event and issues assistance request for assistance to depress the elevator call button to open the elevator door at the first floor and depress a button to deliver robot 10 to the third floor for continuance of the sequence of operation. The sequence of operations can be temporarily halted to await response to the assistance request and robot 10 can wait by the elevator door for assistance. The selected available assistant resource can manually resolve the interruption event independently from robot 10 at the site of the interruption event. For example, the responding selected available assistant resource pushes the elevator call button while robot 10 remains inactively waiting by the elevator door.

Assistance requests can include auditory (e.g., speech, bells, buzzing), visual (e.g., lights blinking, direction or orientation of robot 10) to solicit assistance of nearby or passing by assistant resource or can be issued as electronic requests such as texts, emails, graphics, etc. to near and remote assistant resources. The manner and frequency of issuing assistance requests can be determined by system 30 and/or robot 10. For example, an auditory or visual assistance request can be issued if robot 10 senses an available assistant resource proximally near robot 10.

A level of criticality of the interference event to the assigned task can be determined locally, by processor 22, or remotely, by processor 34. The criticality, or priority level, of the assigned task and/or sub-task in the sequence of operations to complete the assigned task can be determined. An assistance request can be issued to one or more of available assistant resources as selected from database 38 by processor 34. Sensors 16 of robot 10 can continue to operate during the halted operation and, upon sensing resolution of the interruption event, robot 10 can continue through sequence of operations to complete the assigned task or until another interruption event occurs. In the event of additional interruption events, the process of soliciting assistance and resolving the interruption event is begun again.

Interruption events can be received from multiple robots 10 at system 30. Interruption events can be prioritized by processor 34 and available assistant resources are selected from database 38 for each interruption event. The type or manner of issuing the assistance request can change based on priority, environment and/or number of requests issued. In one example, a first assistance request can be issued via a text message to selected available assistant resource. Techniques can be employed to escalate assistance requests in system. For example, if no response is received and/or the interruption event is sensed as unresolved after a predetermined amount of time, a second assistance request can be issued via a visual indicator, such as a blinking light, indicating that assistance is still requested and/or an additional text message can be issued to additionally selected available assistant resources.

System 30 can evaluate and determine an escalation of assistance requests when interruption event is not resolved with first assistance request and/or by first responding available assistance resource. Additional assistance requests can be issued if the assigned task remains uncompleted and if determined to be of high priority. Additional requests can be issued after predetermined amount of time has elapsed since initial request remains unfulfilled, task is determined to be incomplete, and/or robot 10 senses interruption event remains unresolved.

System 30 efficiently assigns, or can accept volunteers, assistant resources 50 to include in database 38 of potentially available assistant resources. Robot 10 interaction with assistant resources is selectively limited to efficiently limit assistant resource interruption from other events. Assistant resources 50 can have limited interaction with robot 10 to resolve interruption event and robot and assistant resources operate independently. In other words, robot 10 retains operation independent of the assistant resources 50 throughout the sequence of operations, including during the interruption event. In some examples, assistant resources 50 provide physical assistance to robot 10 to resolve the interruption event. In any regard, robot 10 maintains operation independent from assistant resources 50. Assistant resources 10 can provide intuitive assistance or assistance that does not undertake specific training. System 30 can provide optimization of assistant resources 50 in resolving interruption events to minimize use of and interruption to assistant resources 50 in order to optimally allocate use of all resources including assistant resources and robot 10. Optimal allocation can maximize the capabilities and productivity of each assistant resource.

Response from the selected available assistant resource(s) can be sensed by robot 10 (e.g., identification scan) or by the assistant resource inputting a response (e.g., pushing a button on robot 10 or other computing device) and can be recorded and/or tracked in database 38. In one example, a non-response of the selected available assistant resources is also recorded and tracked.

In some examples, responses to assistance requests are tracked and recorded to provide incentives, or rewards, to encourage assistant resources to work with, and respond to, the assistance requests. In some events, an assistant resource can be near or passing by robot 10 that is at an apparent or potential interruption event and the passing assistant resource can elect to assist robot 10 with or without the robot's request for assistance in resolving the interruption event. In some examples, unsolicited and solicited responses from assistant resources that assist robot 10 in completing assigned tasks can be tracked and recorded. The quantity of responses to the assistance requests, timeliness of the responses, and whether the interruption event was resolved, amongst other elements, can be tracked. Tracking and recording of assistance request responses can occur over a pre-determined period of time, for example. Criteria for the issuance of the incentive can be pre-established or determined during tracking. For example, an assistant resource with the most responses over a period of three consecutive months may be issued an incentive or reward.

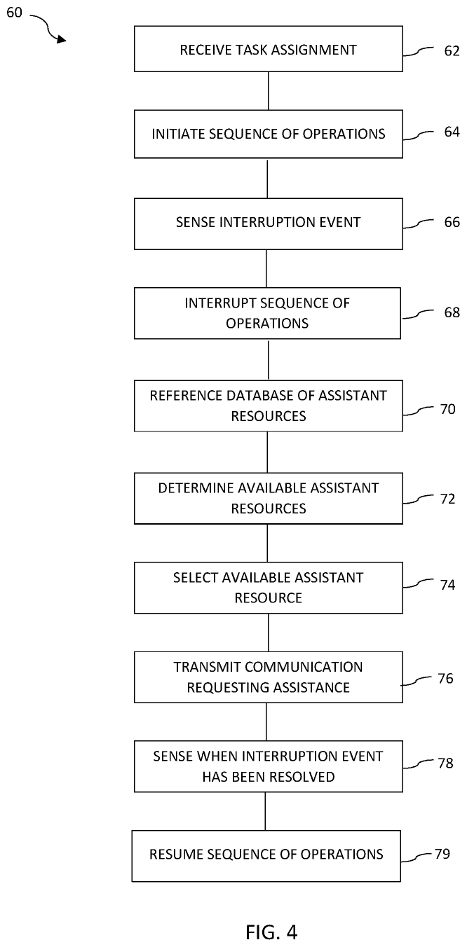

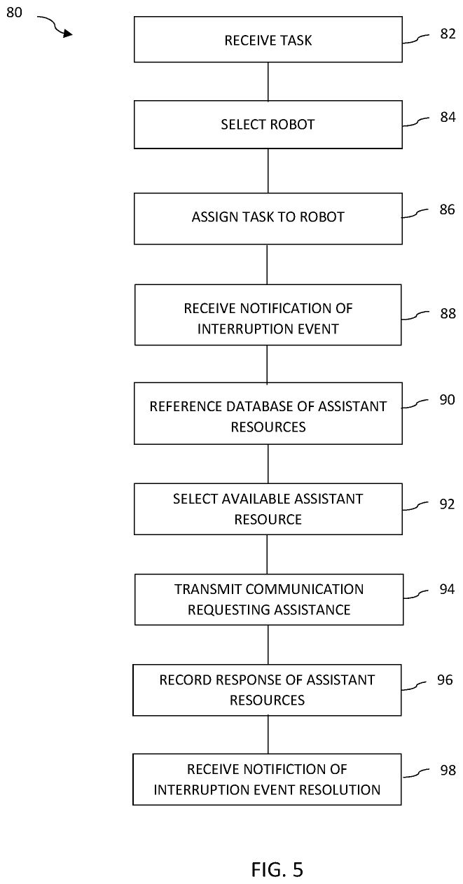

FIG. 4 illustrates a flow chart of an example method 60 of operating a robot in accordance with aspects of the present disclosure. At 62, a task assignment for the robot is received. At 64, a sequence of operations associated with the robot performing the task assignment is initiated. At 66, an interruption event to the sequence of operations at a first location of the robot is sensed. At 68, the sequence of operations is interrupted. At 70, a database of assistant resources is referenced. At 72, available assistant resources are determined from the database of assistant resources. At 74, an available assistant resource is selected from the database to assist with resolving the interruption event at the first location. At 76, a communication requesting assistance to the selected available assistant resource to assist at the first location is transmitted. At 78, when the interruption event has been resolved is sensed. At 79, the sequence of operations is resumed from the interruption event.

FIG. 5 illustrates a flow chart of an example method 80 of operating a robotic system in accordance with aspects of the present disclosure. At 82, a task is received at the system. At 84, a robot is selected to perform the task. At 86, the task is assigned to the robot. At 88, the system receives notification of an interruption event from the robot performing the assigned task. At 90, a database of assistant resources is referenced. At 92, suitable available assistant resources are selected. At 94, communication requesting assistance is transmitted to selected assistant resources. At 96, response of the assistant resources is recorded. At 98, notification of the resolution to the interruption event is received.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of operating a robot comprising:
receiving a task assignment for the robot;
initiating a sequence of operations associated with the robot performing the task assignment;
sensing an interruption event to the sequence of operations at a first location of the robot;
interrupting the sequence of operations;
referencing a database of assistant resources;
determining available assistant resources from the database of assistant resources;
selecting an available assistant resource from the database to assist with resolving the interruption event at the first location;
transmitting a communication requesting assistance to the selected available assistant resource to assist at the first location;
sensing when the interruption event has been resolved; and
resuming the sequence of operations from the interruption event.

2. The method of claim 1, comprising:
tracking a response of the assistant resources to the interruption event.

3. The method of claim 2, comprising:
modifying the database in response to the tracking.

4. The method of claim 1, comprising:
determining a response of the selected available assistant resource to the communicated assistance request during a first time period.

5. The method of claim 1, wherein the selected available assistant resource includes at least two assistant resources.

6. The method of claim 1, wherein the transmitting of communication is electronic communication to an electronic device associated with the selected available assistant resource.

7. A robot comprising:
a mobility mechanism to effectuate movement of the robot through a sequence of operations associated with the robot performing a task assignment;
a communication module to receive instructions related to the task assignment;
a control module including memory to store the instructions and a processor to execute the instructions to perform the sequence of operations associated with the robot performing the task assignment, the control module to control the mobility mechanism through the sequence of operations, the processor to execute the instructions to interrupt the sequence of operations in response to an interruption event;
a first sensor to sense the interruption event to the sequence of operations;
the communication module to transmit a communication requesting assistance from a selected assistant resource of multiple assistant resources to perform a subtask, independent from the robot, to resolve the interruption event; and
a second sensor to sense when the interruption event has been resolved independent from the robot;
the processor to execute the instructions to resume the sequence of operations from the interruption event.

8. The robot of claim 7, wherein the first and second sensors are the same sensor.

9. The robot of claim 7, wherein the communication module transmits at least one of data, audio, and video sensed by the sensor.

10. The robot of claim 7, wherein the sensor is a camera.

11. The robot of claim 7, wherein the sensor is a global positioning sensor.

12. A robotic system comprising:
memory to store a task assignment including instructions;
a processor to execute the task assignment to instruct a robot to perform a sequence of operations associated with the task assignment; and
a communication system to communicate data related to the task assignment between the processor and the robot including data of an interruption event to the robot performing the sequence of events; and
a database of assistant resources;
the processor to determine available assistant resources from the database of assistant resources and select an available assistant resource from the database to assist with resolving the interruption event;
the communication system to communicate an assistance request to the selected available assistant resource to assist resolving the interruption event independent from the robot;
the database to track a response of the assistant resources to the interruption event; and
the processor to modify the database in response to the tracking.

13. The robotic system of claim 12, comprising:
a network device associated with the assistant resource to receive a communication request for assistance to resolve the interruption event to the task assignment.

14. The robotic system of claim 12, comprising:
selecting a robot of a group of robots to complete the task assignment.

15. The robotic system of claim 12, wherein the robot includes memory and a processor.
